(19) United States
(12) Patent Application Publication
(10) Pub. No.: US 2011/0316719 A1
(43) Pub. Date: Dec. 29, 2011

(54) INTERSECTION SAFETY DRIVING SYSTEM

(75) Inventors: Yukio Obuchi, Saitama-shi (JP); Yoshiaki Mayuzumi, Saitama-shi (JP)

(73) Assignee: COSMO RESEARCH CO., LTD., Saitama-shi (JP)

(21) Appl. No.: 12/822,044

(22) Filed: Jun. 23, 2010

(51) Int. Cl. G08G 1/07; G08G 1/095

(52) U.S. Cl. 340/917; 340/944

(57) ABSTRACT

A vehicle sensor and a human sensor are comprised to a traffic sign and the road surface indicator, and warning is displayed in mark, indicate lamp where a driver is easy to make viewing. With intersection safety driving system 100, the control unit can detect vehicle V1, V2 which are going to come in the intersection by vehicle sensor 112 comprised on the traffic sign which there is. When vehicle sensor 112 did vehicle V1, V2, indication to rouse (in indicating lamp 1A, 1B, 1C, 1D), the attention to the vehicle in traffic sign 8A, 8B, 8C, 8D installed in the road which the vehicle drives and the intersecting road is performed.

### FIELD OF THE INVENTION

The present invention relates to the cross point safety travel motion system which can prevent an accident with the collision between vehicles in the cross point and a vehicle and a human. The present invention relates to the intersection safety driving system comprising a vehicle sensor and the human sensor to a traffic sign and a road surface indicator specifically, and relates to the intersection safety driving system which can display warning to the mark or the indicate lamp which a driver is easy to perform viewing of.

### BACKGROUND ART

The road which is not the through highway of the intersection where a road and the prospect that hung restraint of the cross point which a prospect has bad conventionally is made are bad may be provided with a road reflecting mirror (a curved mirror) in order to ensure the safety (reference such as Japanese Patent Laid-Open No. 2007-120,010).

Related technologies are described, for example, in Japanese Patent Laid-Open No. 2001-084486.

### SUMMARY OF THE INVENTION

### Problem to be Solved by the Invention

However, because there is “blind spot” (the domain that is not visible enough) in the reflection image of the road reflecting mirror, an accident may produce. Also, because reflection image is a symmetry, an accident may occur because of the mistake of the driver. The object of the present invention is to provide the intersection safety driving system which can prevent the accident (the collision between vehicles and a vehicle and a human and an accident) in the intersection. According to the present invention, a vehicle sensor and the human sensor are provided to a traffic sign and the road surface indicator, and warning is displayed to the traffic sign, the road surface indicator.

### Means to Solve the Problem

The intersection safety driving system of the present invention assumes (7) subject matter from (1). (1) The intersection safety driving system including a vehicle sensor and indicating lamp and the traffic sign comprising a control unit being installed in each entrance of the intersection, respectively. When the vehicle which is going to come in the above intersection by the vehicle sensor comprised in the neighborhood (e.g., a traffic sign) of the intersection was detected, the control unit performs indication to rouse the attention to the above vehicle in indicate lamp comprised on the traffic sign installed in the road which the vehicle drives and the intersecting road. In this case, the control unit performs indication to rouse the attention to the above vehicle in indicate lamp comprised on the traffic sign installed in the road intersecting the road which the vehicle drives. The intersection safety driving system of the present invention is typically applied to the intersection where there is not a signal and a prospect is bad. In the present invention, “the vehicle” means the vehicles which mainly receive the limit of the signal except the walker such as an automobile (including the motorcycle), a motor bike, a light vehicle (including the bicycle), a trolley-bus, a carriage. Also, a wheelchair (including the electric wheelchair) is included in “a walker”. The vehicle sensor can be provided to the structure (a traffic sign structure) which “a temporal stop”, mark in itself such as “the going slowly” or a mark is attached, for example, to the vehicle sensor can be assumed a radar comprised to the traffic sign structure. Also, the vehicle sensor can be assumed a camera comprised to the traffic sign structure, and in this case the control unit can detect a vehicle by performing the shape recognition of the captured image. Note that, as a vehicle sensor, an ultrasonic sensor, a metal locator, a light range sensor can be used. If a indicate lamp is the lamp which can indicate a direction, any kind of thing can be used. Specifically, while display by the indicating lamp may be the triangle that stood, for example, still, and turning on, it may be a triangle to move.

(2) The intersection safety driving system including a vehicle sensor and indicating lamp and the road surface indicator comprising a control unit being installed in the center of the intersection. When the vehicle which is going to come in the cross point by the vehicle sensor was detected, the control unit displays indication to rouse attention to the other vehicles which are going to come in the intersection among vehicles driving the road which the vehicle drives and an intersecting road in above indicate lamp. A radar comprised to the road surface indicator as a vehicle sensor can be used. Also, a camera comprised to the road surface indicator as a vehicle sensor can be used, and in this case the control unit can detect a vehicle by performing the shape recognition of the captured image.

(3) The intersection safety driving system including vehicle detection facilities having a vehicle sensor and a transmitter and a control unit are installed in the intersection, and an above transmitter transmitting information to a vehicle comprising the receiver circuit. The control unit can detect the vehicle which there is which is going to come in the cross point by the vehicle sensor. In this case, the control unit transmits detection information to a vehicle comprising the above receiver circuit which is going to come in the intersection among vehicles driving the road which the vehicle drives by the transmitter and an intersecting road. That is, a vehicle sensor detects whether “a certain vehicle” is going to come in cross point. The control unit transmits detected information to “the other vehicles” which are going to come in the intersection among vehicles driving a road intersecting the road which “a certain vehicle” drives. For example, the information is the information that which road “a certain vehicle” is going to come in cross point from.

(4) The intersection safety driving system including a traffic sign having a human sensor and indicating lamp and a control unit being installed in each entrance of the intersection, respectively. The control unit can detect a human or a bicycle by an above human sensor comprised in the neighborhood (the traffic sign which, e.g., there is) of the intersection in the vicinity of a intersection. The control unit performs indication to rouse the attention to an above human or the above bicycle in indicating lamp comprised on each traffic sign. An infrared camera attached to a traffic sign structure as a human sensor can be used. In this case, the control unit can detect a human (including the driver of the bicycle and the user of the wheelchair) by performing temperature recognition. Also, a camera attached to the structure which is on a traffic sign as a human sensor can be used. In this case, the control unit can detect a human, a wheelchair, a bicycle by performing the configuration recognition of the captured image.

(5) The intersection safety driving system including a human sensor and indicating lamp and the road surface indicator comprising a control unit being installed in the center of the intersection. When a human was detected by an above human sensor comprised to a certain road surface indicator in the vicinity of a intersection, the control unit performs indication to rouse the attention to an above human or the above bicycle in indicate lamp comprised to each road surface indicator. An infrared camera attached to a road surface indicator as a human sensor can be used. In this case, the control unit can detect a human or a bicycle by performing temperature recognition. Also, a normal camera attached to a road surface indicator as a human sensor can be used. In this case, the control unit can detect a human or a bicycle by performing the configuration recognition of the captured image. Note that, as a human sensor, an ultrasonic sensor, optical sensor can be used other than an infrared camera and a normal camera.

(6) The intersection safety driving system including a human sensor and a transmitter and the human detection facilities comprising the control unit are installed in the crossover, and an above transmitter transmitting information to a vehicle comprising the receiver circuit. When a human passing the intersection neighborhood by the human sensor was detected, the control unit transmits information to suffer from the above detection to the above vehicle which is going to come in the intersection among vehicles driving the road which the human passes by an above transmitter and an intersecting road. In the present embodiment, the intersection safety driving system transmits information to a vehicle comprising the receiver circuit. For example, an infrared sensor provided to a traffic sign and the road surface indicator as a human sensor can be used. In this case, the control unit transmits information to arouse the existence of the walker from a communication circuitry when an infrared sensor detected the existence such as walkers. Also, a GPS terminal capabilities-based cell-phone can be adopted as a human sensor. In this case, a communication circuitry receives location information sent to by a cell-phone, and the control unit transmits location information to the vehicle which is going to come in cross point from this communication circuitry.

(7) The intersection safety driving system that a mobile station radio unit comprised on the preparation et al.

obtained fixed station radio unit and vehicle on a traffic sign communicates, wherein, the fixed station radio unit has RF integrated circuit built in a signal of the arbitrary frequency which the fixed station radio unit reduces a radio frequency band signal received by an antenna in arbitrary frequency, and was input into other circuits from a demodulation circuit to output and the circuit of above others is raised in a radio frequency, and the developmental RF integrated circuit which had the switching circuit which changes a modulation circuit to output and an above antenna to either of an above demodulation circuit and the above modulation circuit built-in is comprised to the above antenna,

Note that, (7) In the intersection safety driving system, a vehicle sensor is the sensor which can detect a vehicle approaching the crossover effectively. What kind of sensor may be used: for example, Optoelectronic switch, a pressure sensitive sensor (the cable-shaped sensor which, e.g., becomes the ON when it is stamped with a tire) can be used as a vehicle sensor. Also, if the people of the intersection neighborhood can be detected, the human sensor can use what kind of sensor. For example, optoelectronic switch, a pressure sensitive sensor (the cable-shaped sensor which, e.g., becomes the ON when it is stamped) can be used as a vehicle sensor.

### Effect of the Invention

A vehicle sensor and the human sensor are provided to a traffic sign and the road surface indicator, and mark, indicate lamp where a driver is easy to perform viewing of warning can prevent an accident with the collision between the vehicles in the intersection and a vehicle and a human in what is displayed.

### BRIEF DESCRIPTION OF DRAWINGS

FIG. 1 is a whole illustration which shows the first embodiment of the intersection safety system of the present invention.

FIG. 2 is a functional block diagram of a vehicle detection unit used in a intersection safety system of FIG. 1.

FIG. 3 is a figure showing the traffic sign in the intersection safety system of FIG. 1, and, in (A), in figure showing traffic sign 8A, (B), in figure showing traffic sign 8B, (C), figure showing traffic sign 8C, (D) are figures showing traffic sign 8D.

FIG. 4 is a whole illustration which shows the second embodiment of the intersection safety system of the present invention.

FIG. 5 is a functional block diagram of the intersection safety system of FIG. 4.

FIG. 6 is the figure where it was a figure, and (A) was watched from the D1 direction, the figure that (B) was watched from the D2 direction which shows the road surface indicator in the intersection safety system of FIG. 4.

FIG. 7 is a whole illustration which shows the third embodiment of the intersection safety system of the present invention.

FIG. 8 is a functional block diagram of the intersection safety system of FIG. 7.

FIG. 9 is a figure which shows the road surface indicator in the intersection safety system of FIG. 7.

FIG. 10 is a figure which shows the state that a road surface indicator produces a wave in a intersection safety system of FIG. 7.

FIG. 11 is a figure which shows vehicle detection mark displayed in a intersection safety system of FIG. 7 by the head up display of the vehicle.

FIG. 12 is a whole illustration which shows the fourth embodiment of the intersection safety system of the present invention.

FIG. 13 is a functional block diagram of a vehicle detection unit used in a intersection safety system of FIG. 12.

FIG. 14 is the figure where it was a figure, and (A) was watched from the D1 direction, the figure that (B) was watched from the D2 direction which shows the road surface indicator in the intersection safety system of FIG. 12.

FIG. 15 is a whole illustration which shows the fifth embodiment of the intersection safety system of the present invention.

FIG. 16 is a functional block diagram of the intersection safety system of FIG. 15.

FIG. 17 is the figure where it was a figure, and (A) was watched from the D1 direction, the figure that (B) was watched from the D2 direction which shows the road surface indicator in the intersection safety system of FIG. 15.

FIG. 18 is a whole illustration which shows the sixth embodiment of the intersection safety system of the present invention.

FIG. 19 is a functional block diagram of the intersection safety system of FIG. 18.

FIG. 20 is a figure which shows the road surface indicator in the intersection safety system of FIG. 18.

FIG. 21 is a figure which shows the state that a road surface indicator produces a wave in a intersection safety system of FIG. 18.

FIG. 22 is a figure which shows human detection mark displayed in a intersection safety system of FIG. 18 by the head up display of the vehicle.

FIG. 23 is a whole illustration which shows the transformation embodiment of the intersection safety system of FIG. 18.

FIG. 24 is a functional block diagram of the intersection safety system of FIG. 22.

FIG. 25 is a block diagram which shows the state that it is the figure showing the RF integrated circuit of a fixed station radio unit in the present invention and the mobile station radio unit, and an RF integrated circuit is connected to a physical layer circuit and an MAC circuit.

FIG. 26 is a block diagram. FIG. 26 subdivides the demodulation circuit of the RF integrated circuit of FIG. 25 and a modulation circuit, and to show.

### DETAILED DESCRIPTION OF SPECIFIED EMBODIMENTS

As follows, the sixth embodiment is described from the first of the present invention. Note that, in each embodiment, the intersection safety system is applied to the cross point of 4 differences road without signal restraint. As for one of these four roads, a crossover becomes the exit of the one way. Also, in each embodiment, it is shown 4 directions of the road toward the crossover in D1, D2, D3, D4, and vehicle V1 drives in the D1 direction leaving for the intersection, and vehicle V2 drives in the D2 direction.

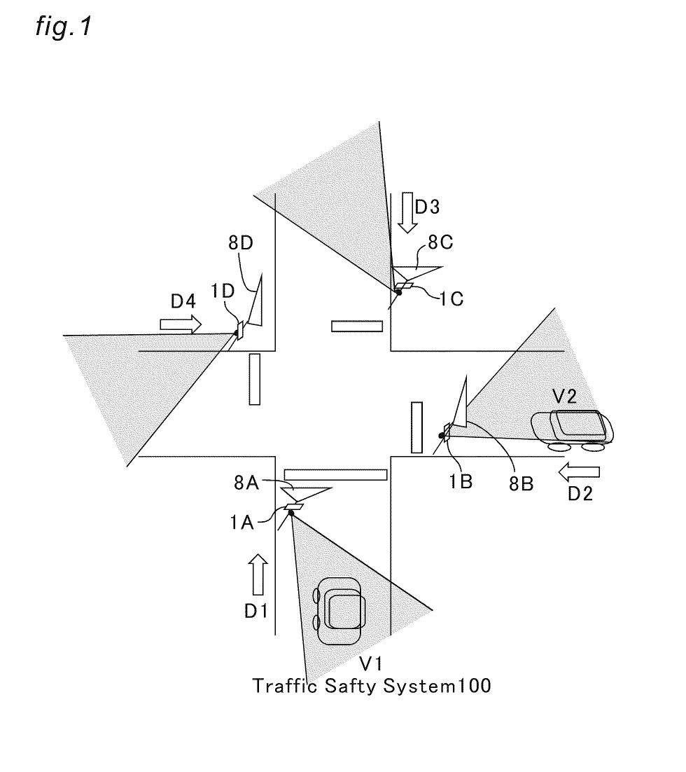

FIG. 1 is a whole illustration which shows the first embodiment of the intersection safety system of the present invention. In this embodiment, as for intersection safety system 100, it is from four vehicle detection unit 1A, 1B, 1C, 1D which are set in traffic sign (with the figure the mark of “the temporal stop”) 8A, 8B, 8C, 8D installed in the entrance of the intersection, respectively.

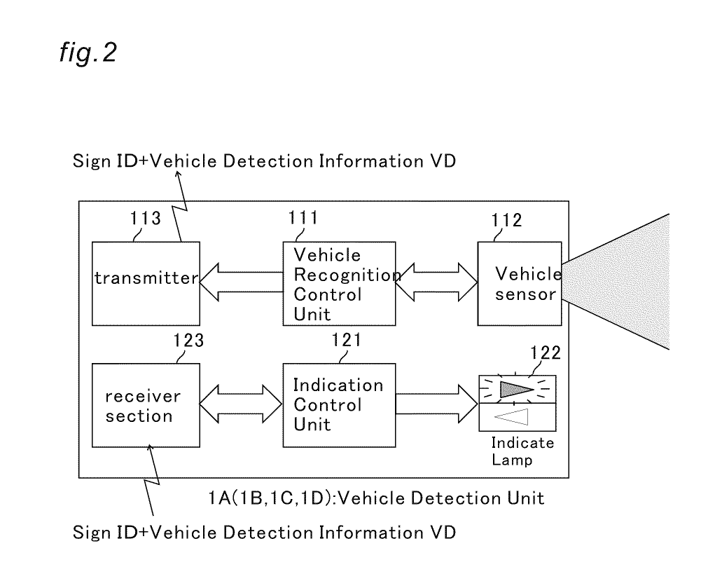

As shown in FIG. 2, in vehicle detection unit 1A, 1B, 1C, 1D, it is with vehicle recognition control unit (a control unit) 111 from vehicle sensor 112 and transmitter 113 and indication control unit 121 and indicate lamp 122 and receiver 123, respectively. Vehicle recognition control unit 111 can detect the vehicle which is going to come in the intersection by vehicle sensor 112 which was comprised in traffic sign 8A, 8B, 8C, 8D, respectively. Vehicle sensor 112 can be assumed, for example, a camera, and vehicle recognition control unit 111 can detect the existence of the vehicle by the change of the captured image. Also, vehicle sensor 112 can be assumed, for example, a radar, and vehicle recognition control unit 111 can detect the existence of the vehicle by size and the change of the reply.

In this embodiment, vehicle detection unit 1A, each vehicle sensor 112 of 1B detect vehicle V1, V2 which are going to come in cross point. And, indication control unit 121 displays vehicle V1, a nudge to V2 in indicate lamp 122 which was comprised on the traffic sign installed in the road intersecting the road which vehicle V1, V2 drive, respectively.

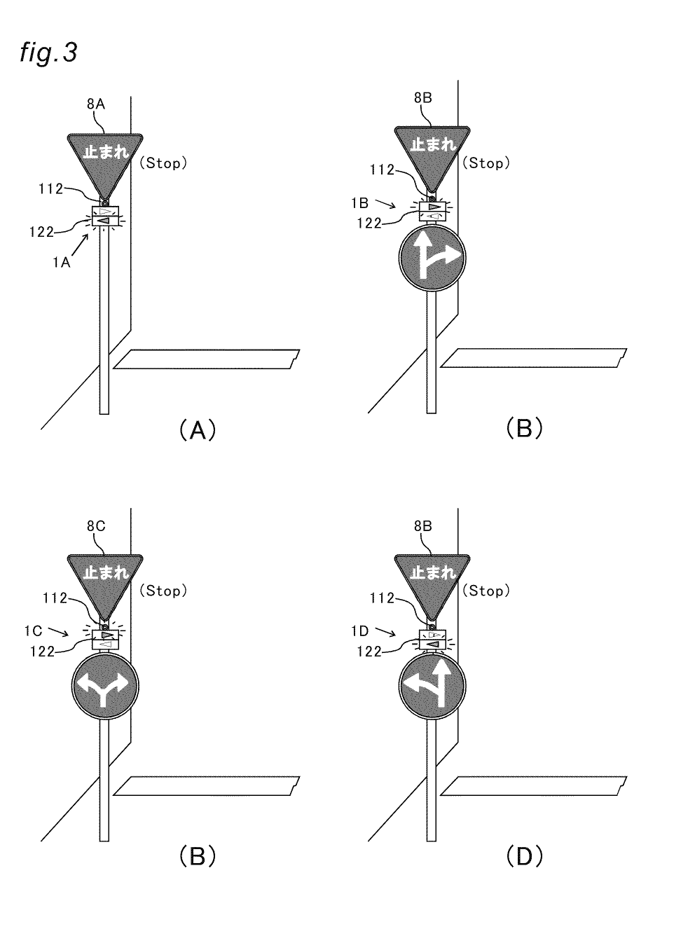

Indication of indicate lamp 122 which was comprised in traffic sign 8B, 8D installed in the road intersecting to the road which vehicle V1 drives, respectively, is shown in FIG. 3(B), (D). Also, indication of indicate lamp 122 which was comprised in traffic sign 8A, 8C installed in the road intersecting the road which vehicle V2 drives, respectively, is shown in FIG. 3(A), (C). In this embodiment, because the existence of a vehicle becoming the blind spot is displayed as shown in FIG. 3(A) . . . (D) by a traffic sign, the collision between the vehicles in the intersection can be prevented.

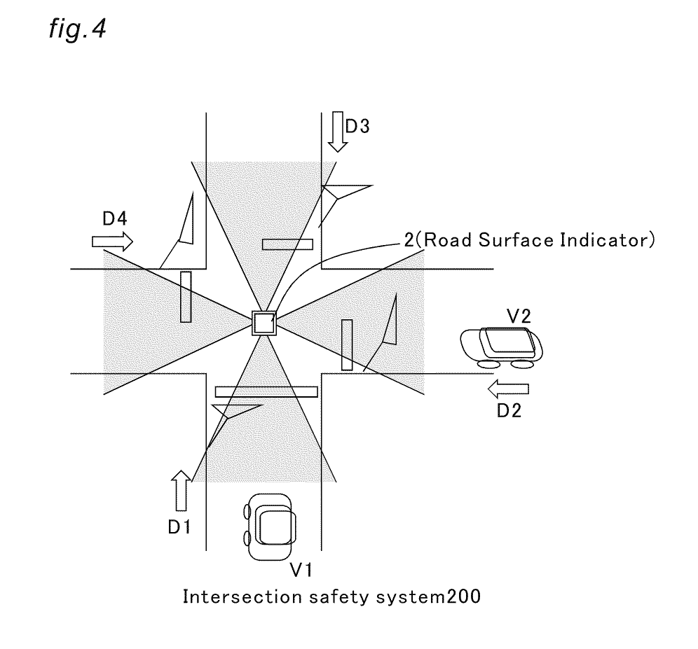

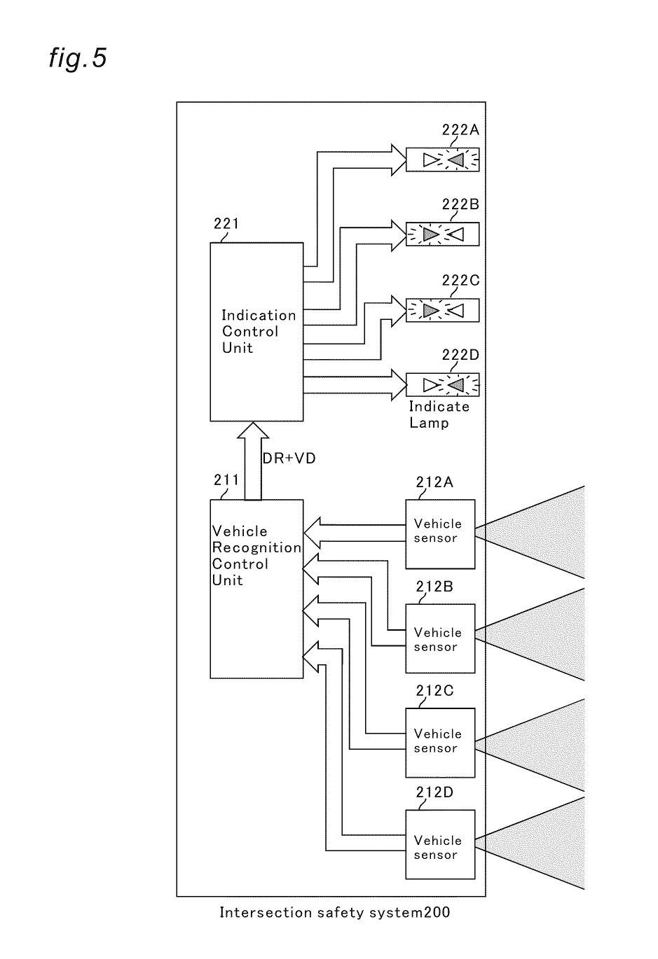

FIG. 4 is a whole illustration which shows the second embodiment of the intersection safety system of the present invention. As shown in FIG. 5, intersection safety system 200 of the present embodiment becomes from road surface indicator 2 installed in the center of the intersection. As for road surface indicator 2, it is from vehicle recognition control unit (a control unit) 211 and vehicle sensor 212A, 212B, 212C, 212D and indication control unit (a control unit) 221 and indicate lamp 222A, 222B, 222C, 222D.

Vehicle recognition control unit 211 can detect the vehicle which is going to come in cross point by vehicle sensor 212A, 212B, 212C, 212D. Vehicle sensor 212A, 212B, 212C, 212D can be assumed, for example, a camera, and vehicle recognition control unit 211 can detect the existence of the vehicle by the change of the captured image. Also, vehicle sensor 212A, 212B, 212C, 212D can be assumed, for example, a radar, and vehicle recognition control unit 211 can detect the existence of the vehicle by size and the change of the reply.

In this embodiment, vehicle sensor 212A, 212B detect vehicle V1, V2 which are going to come in cross point. And, indication control unit 221 displays a nudge in indicate lamp appearing from other vehicles driving a road intersecting the road which vehicle V1, V2 drive.

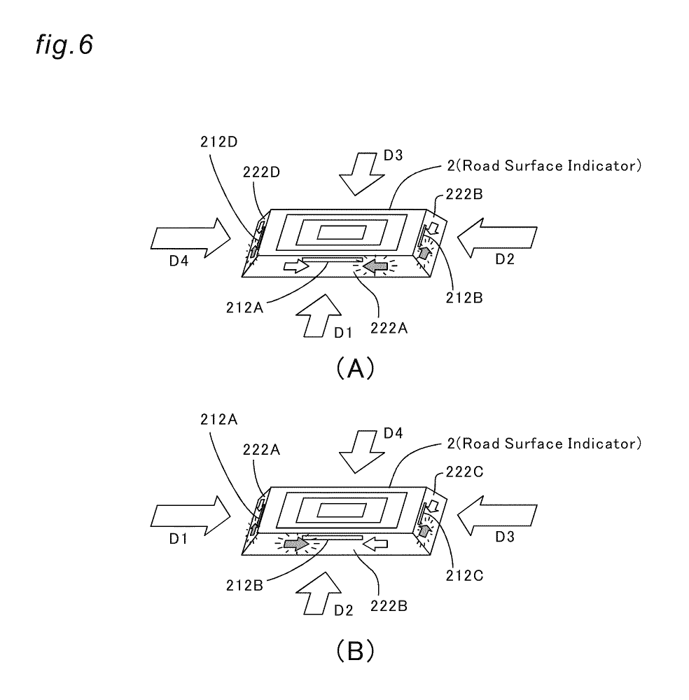

A lighting state of road surface indicator 2 watched from the D1 direction is shown in FIG. 6(A), and a lighting state of road surface indicator 2 watched from the D2 direction is shown in FIG. 6(B). Because the existence of a vehicle becoming the blind spot is displayed as shown in FIG. 6(A), (B) by a road surface indicator, even the present embodiment can prevent the collision between the vehicles in the intersection.

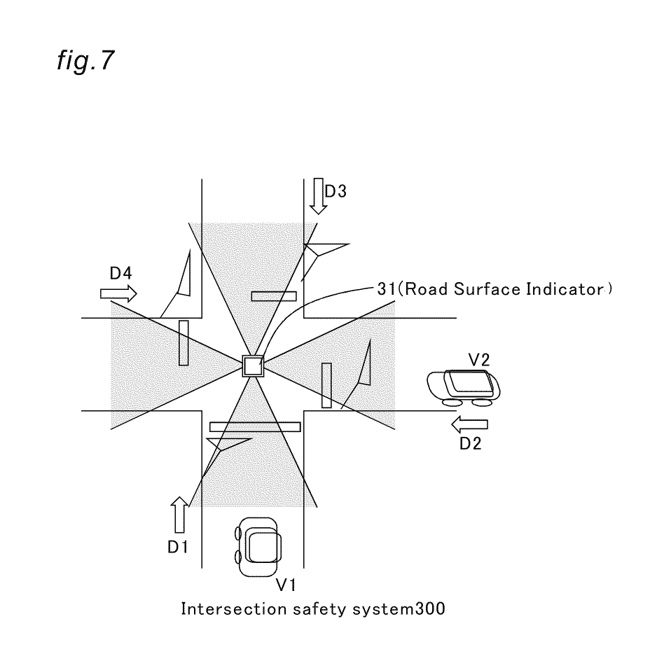

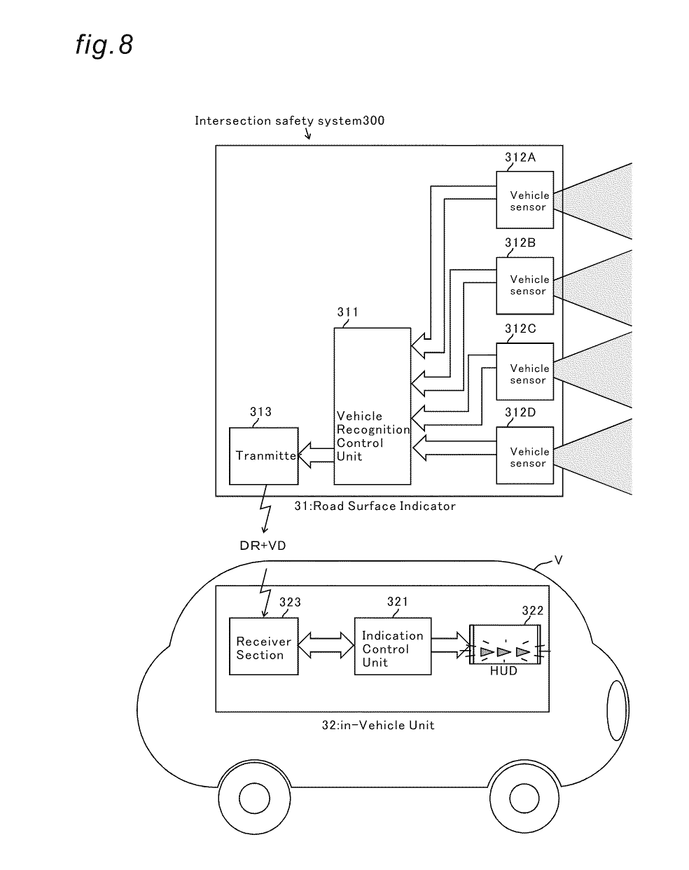

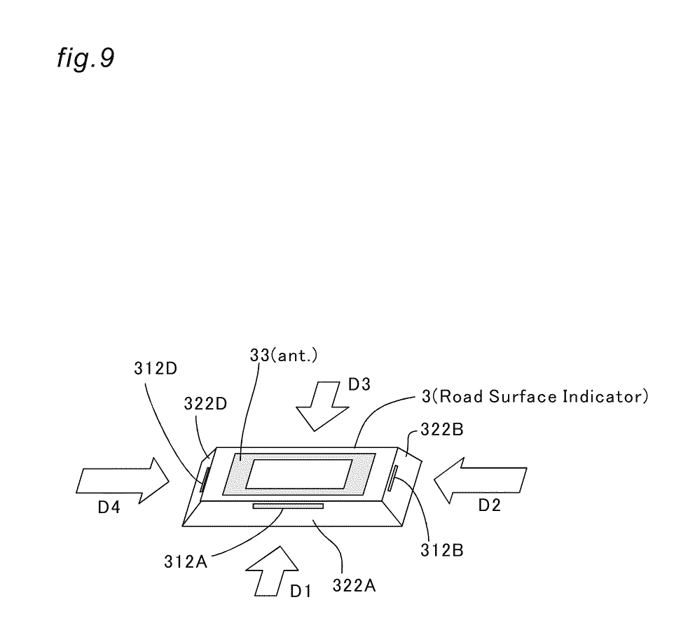

FIG. 7 is a whole illustration which shows the third embodiment of the intersection safety system of the present invention. As shown in FIGS. 7 and 8, as for intersection safety system 300 of the present embodiment, it is from the in-vehicle unit 32 registered by road surface indicator 31 (in FIG. 9 showing the appearance) installed in the center of the intersection and a vehicle (it is shown in FIG. 7 in V1, V2 in FIG. 8 as shown in V). As for road surface indicator 31, it is from vehicle recognition control unit (a control unit) 311 and vehicle sensor 312A, 312B, 312C, 312D and transmitter 313 (including antenna 33). The in-vehicle unit 32 consists of indication control unit (a control unit) 321 and head up display 322, receiver 323.

Vehicle recognition control unit 311 can detect the vehicle which is going to come in cross point by vehicle sensor 312A, 312B, 312C, 312D. Vehicle sensor 312A, 312B, 312C, 312D can be assumed, for example, a camera, and vehicle recognition control unit 311 can detect the existence of the vehicle by the change of the captured image. Vehicle sensor 312A, 312B, 312C, 312D can be assumed, for example, a radar. Vehicle recognition control unit 311 can detect the existence of the vehicle by size and the change of the reply.

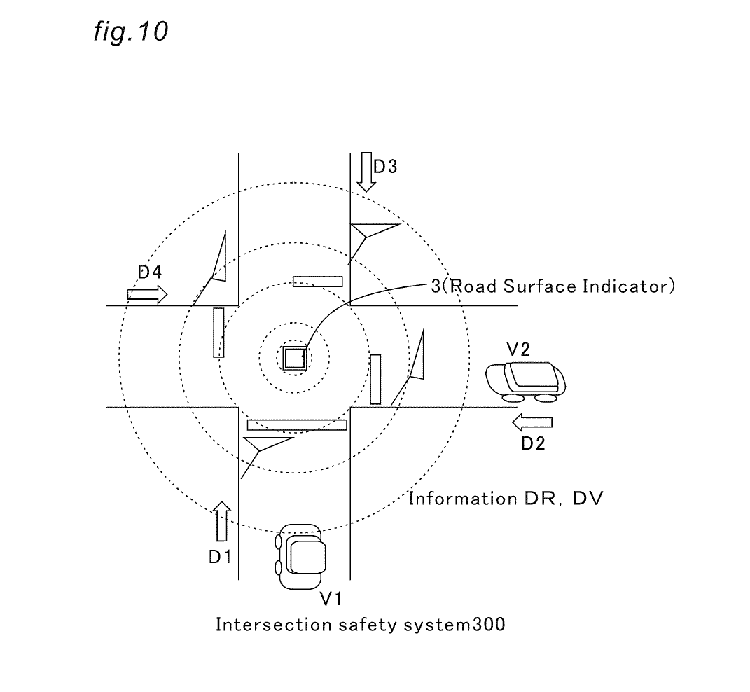

In this embodiment, vehicle sensor 312A, 312B detect vehicle V1, V2 which are going to come in cross point. Vehicle recognition control unit 311 transmits predetermined information (direction information DR and vehicle detection information VD) to receiver 323 of the vehicle from transmitter 313 (it refers to the figure showing the state that a road surface indicator of FIG. 10 produces a wave other than FIG. 8), and indication control unit 321 displays a nudge to a head up display (HUD) in vehicle V1, V2.

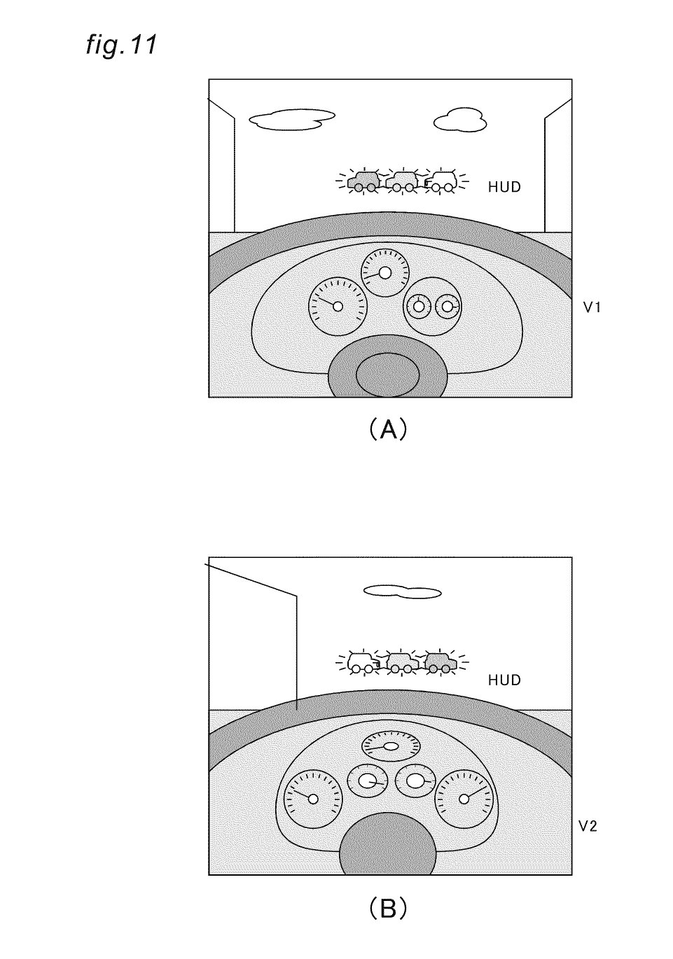

An indication state of the head up display (HUD) of vehicle V1 is shown in FIG. 11(A), and the indication state of the head up display (HUD) of vehicle V2 is shown in FIG. 11 (B). Because the existence of a vehicle becoming the blind spot is displayed as shown in FIG. 11(A), (B) by the head up display of each vehicle, even the present embodiment can prevent the collision between the vehicles in the intersection.

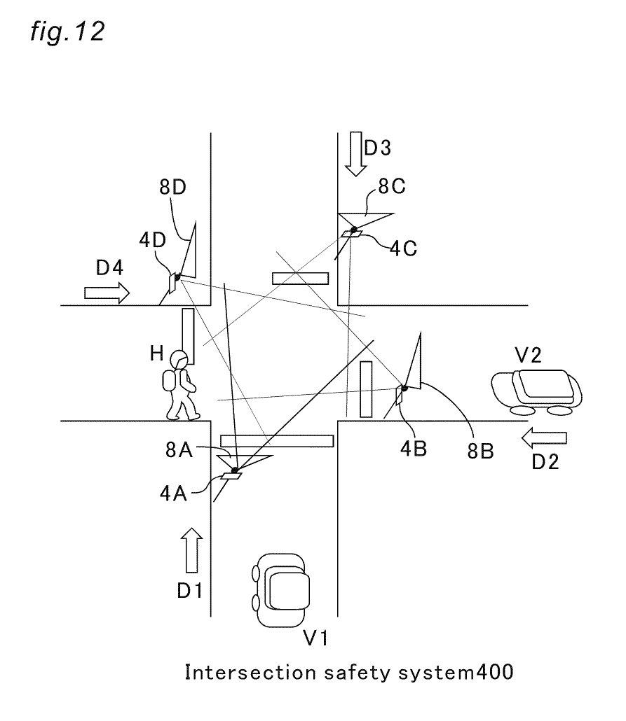

FIG. 12 is a whole illustration which shows the fourth embodiment of the intersection safety system of the present invention. In this embodiment, as for intersection safety system 400, it is from four human detection unit 4A, 4B, 4C, 4D which are set in traffic sign (with the figure the mark of “the temporal stop”) 8A, 8B, 8C, 8D installed in the entrance of the intersection, respectively.

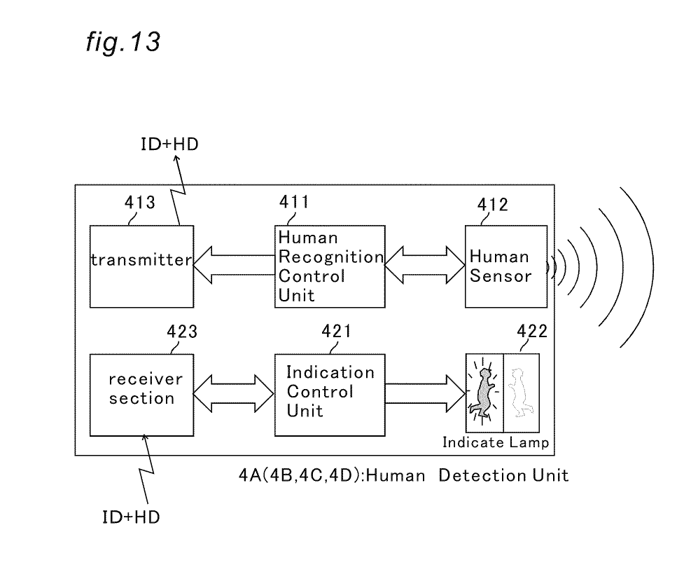

As shown in FIG. 13, in human detection unit 4A, 4B, 4C, 4D, it is with human recognition control unit (a control unit) 411 and human sensor 412 from transmitter 413 and indication control unit 421 and indicate lamp 422 and receiver 423, respectively. Human recognition control unit 411 can detect the walker (or the driver of the bicycle) of the intersection neighborhood of a point by human sensor 412 which was comprised in traffic sign 8A, 8B, 8C, 8D, respectively. Human sensor 412 can be assumed, for example, an infrared camera, and human recognition control unit 411 can detect the existence of the human by the light and shade of the captured image. Also, human sensor 412 can be assumed, for example, color television camera, and human recognition control unit 411 can detect the existence of the human by size and the movement change of the image.

In this embodiment, by human detection unit 4A, 4B, 4C, detection information of each human sensor 412 of 4D, the presence of the walker of the intersection neighborhood of a point and a position are detected. And, indication control unit 421 performs nudge indication to walker H in traffic sign 8A, 8B, 8C, indicate lamp 122 of 8D. Note that, because it is well-known, the position sensing technology of the walker omits explanation. Also, a walker omits the explanation in a detection technology of the walker presence in case of the plural number and the walker position sensing technology being well-known.

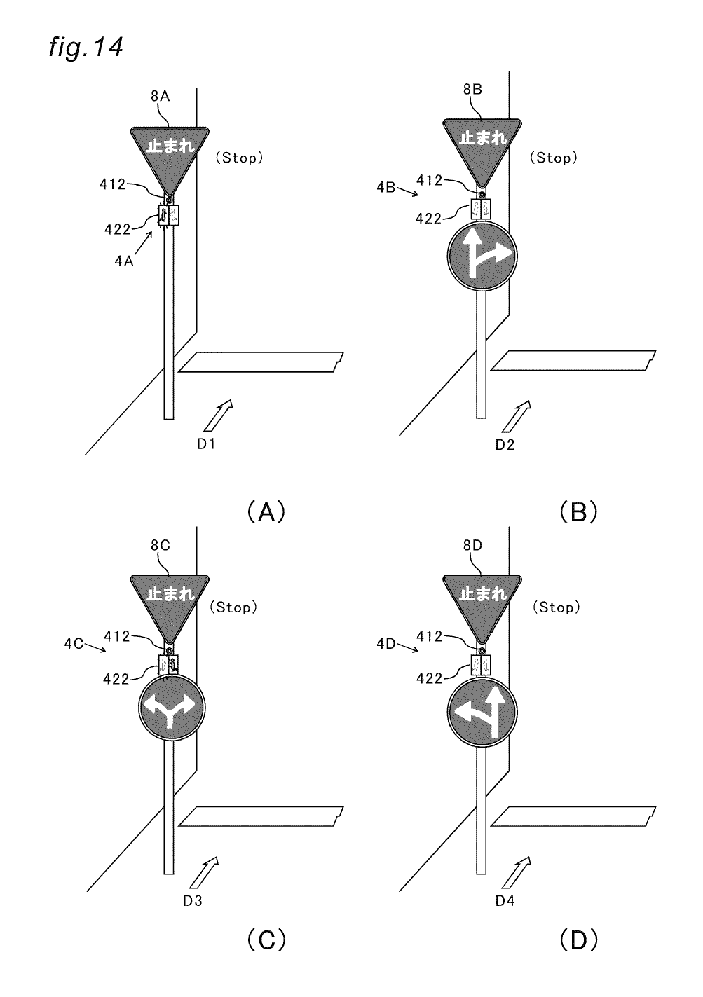

Indication of indicate lamp 422 which was comprised in traffic sign 8A, 8B, 8C, 8D when there is walker H at the position shown in FIG. 12, respectively, is shown in FIG. 14(A), (B), (C), (D). In this embodiment, because the existence of a human becoming the blind spot is displayed as shown in FIG. 14(A) . . . (D) by a traffic sign, the vehicle in the intersection and the accident with the walker (or a bicycle) can be prevented.

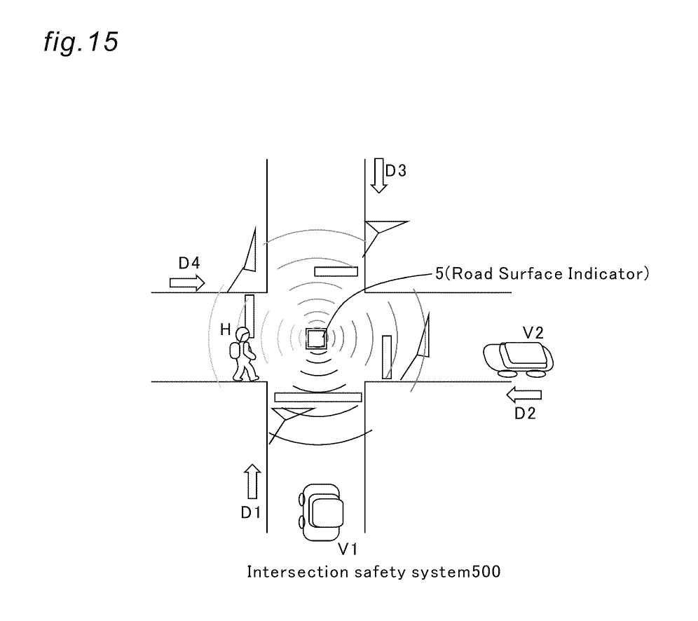

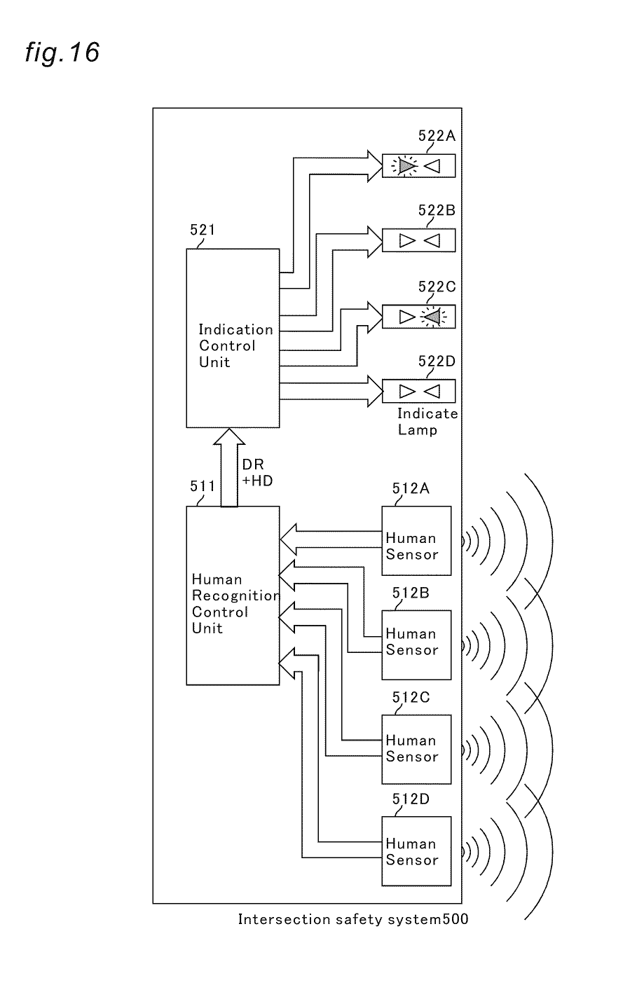

FIG. 15 is a whole illustration which shows the fifth embodiment of the intersection safety system of the present invention. As shown in FIG. 15, intersection safety system 500 of the present embodiment becomes from road surface indicator 5 installed in the center of the intersection. As for road surface indicator 5, it is as shown in FIG. 16 from human recognition control unit (a control unit) 511 and human sensor 512A, 512B, 512C, 512D and indication control unit (a control unit) 521 and indicate lamp 522A, 522B, 522C, 522D.

Human recognition control unit 511 can detect the walker (or the driver of the bicycle) of the intersection neighborhood of a point by human sensor 512A, 512B, 512C, 512D comprised to road surface indicator 5. Human sensor 512A, 512B, 512C, 512D can be assumed, for example, an infrared camera, and human recognition control unit 511 can detect the existence of the human by the light and shade of the captured image. Also, human sensor 512A, 512B, 512C, 512D can be assumed, for example, color television camera, and human sensor 512A, 512B, 512C, 512D can detect the existence of the human by size and the movement change of the image.

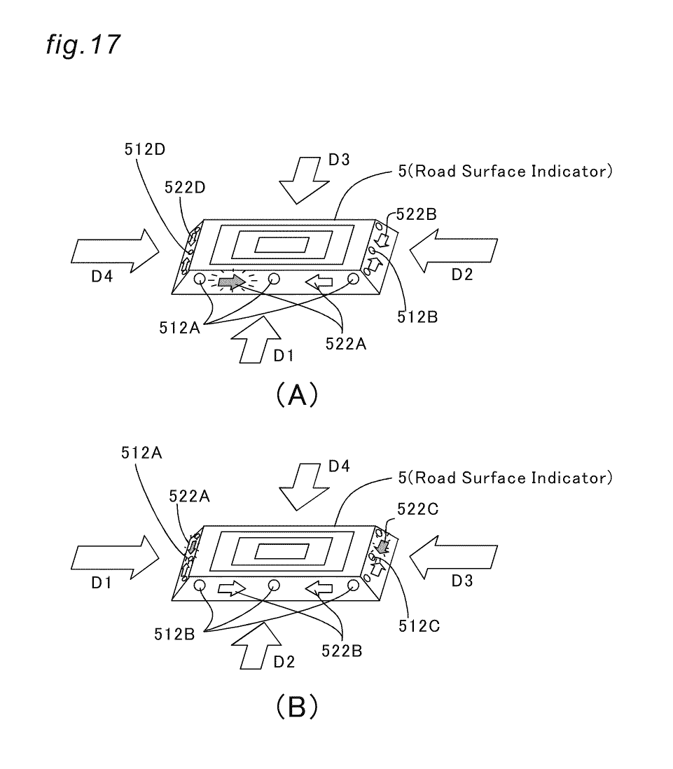

In this embodiment, human sensor 512D detects walker H near the intersection. And, an indication control unit performs nudge indication to a predetermined indicate lamp. A lighting state of road surface indicator 5 watched from the D1 direction is shown in FIG. 17(A), and a lighting state of road surface indicator 5 watched from the D2 direction is shown in FIG. 17(B). Because the existence of the walker is displayed as shown in FIG. 17(A), (B) by a road surface indicator, even the present embodiment can prevent the accident with a walker (or a bicycle) and the vehicle in the intersection. Note that, in FIG. 17(A), (B), one surface of road surface indicator 5 is provided with three cameras, and that view gets narrow by mud is prevented.

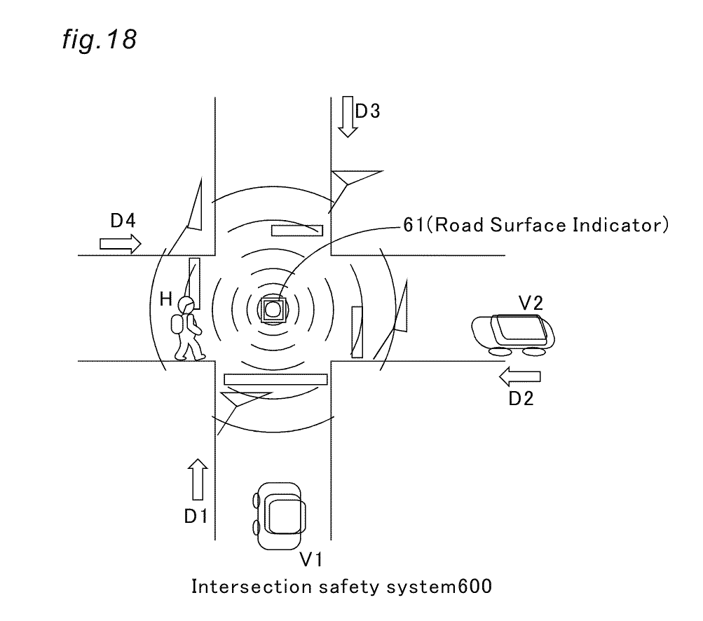

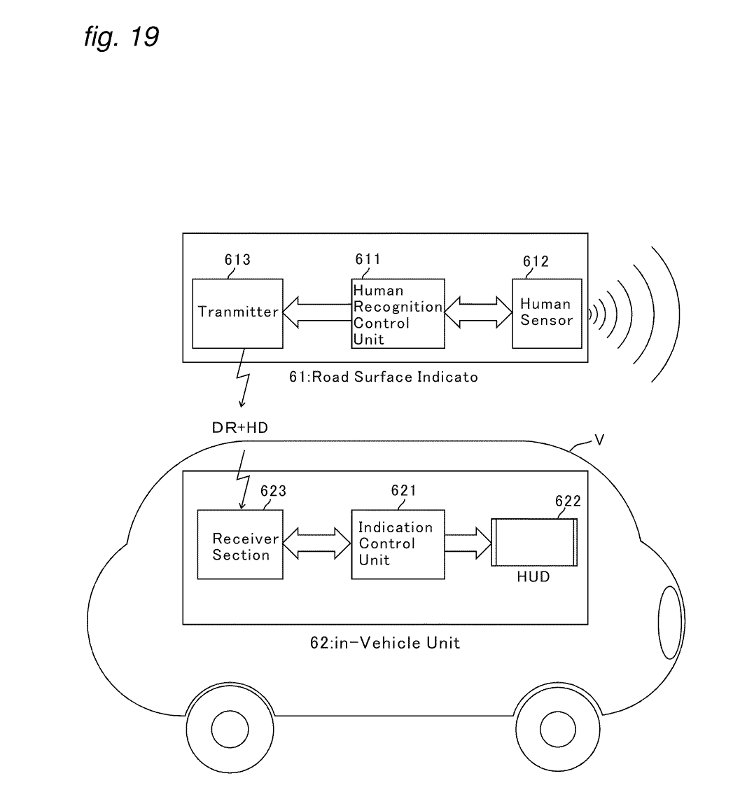

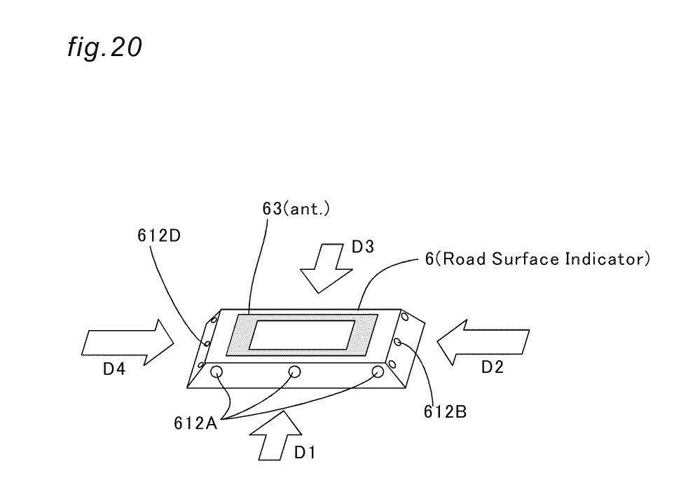

FIG. 18 is a whole illustration which shows the sixth embodiment of the intersection safety system of the present invention. As shown in FIGS. 18 and 19, as for intersection safety system 600 of the present embodiment, it is from the in-vehicle unit 62 registered by road surface indicator 61 (in FIG. 20 showing the appearance) installed in the center of the intersection and a vehicle (it is shown in FIG. 18 in V1, V2 in FIG. 19 as shown in V). Road surface indicator 61 consists of human recognition control unit (a control unit) 611 and human sensor 612A, 612B, 612C, 612D and transmitter (including antenna 63) 613. The in-vehicle unit 62 consists of indication control unit (a control unit) 621 and head up display 622, receiver 623.

Human recognition control unit 611 can detect the walker (or a bicycle driver) near the intersection by human sensor 612A, 612B, 612C, 612D. Human sensor 612A, 612B, 612C, 612D can be assumed an infrared camera, and human recognition control unit 611 can detect the existence of the human by the light and shade of the captured image. Also, human sensor 612A, 612B, 612C, 612D can be assumed, for example, color television camera, and human sensor 612A, 612B, 612C, 612D can detect the existence of the human by size and the movement change of the image.

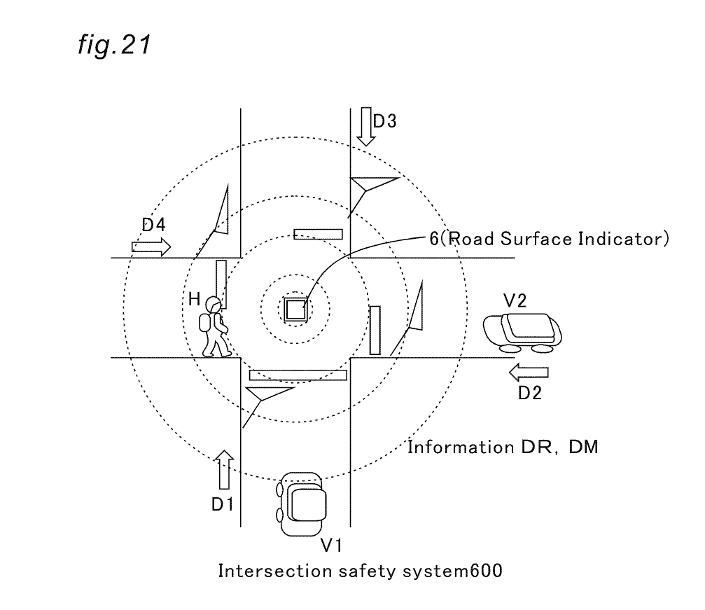

In this embodiment, human sensor 612D detects a walker of the neighborhood of crossover. Human recognition control unit 611 transmits predetermined information (direction information DR and human detection information HD) to receiver 623 of vehicle V1 from transmitter 613 (it refers to the figure showing the state that a road surface indicator of FIG. 21 produces a wave other than FIG. 19), and indication control unit 621 displays a nudge to a head up display (HUD) in vehicle V1.

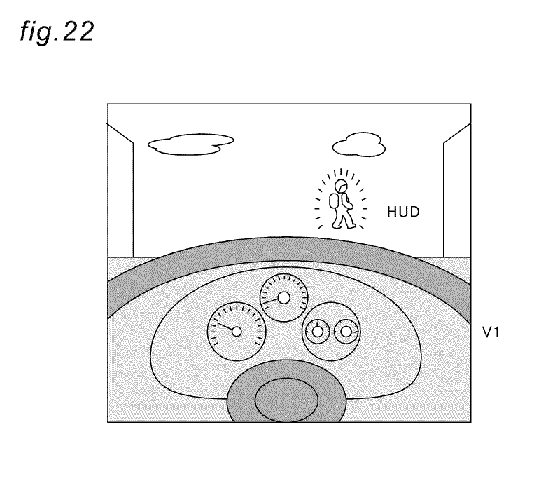

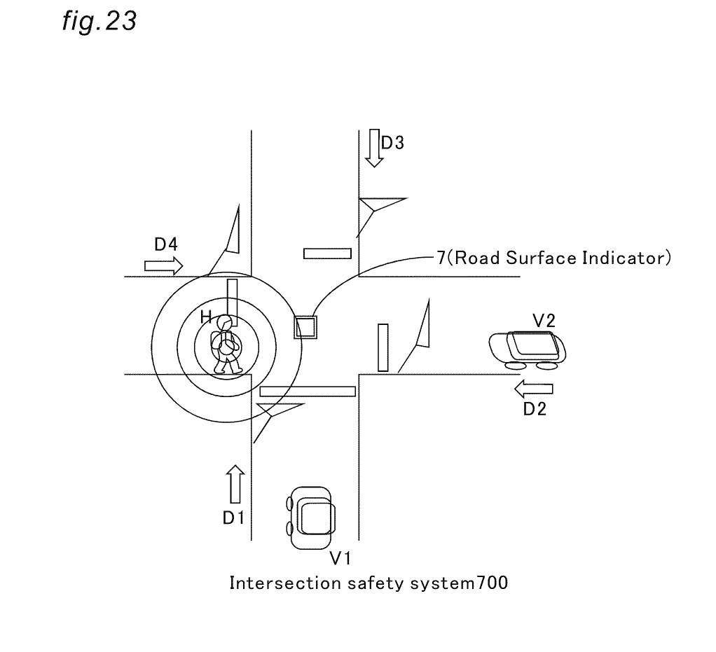

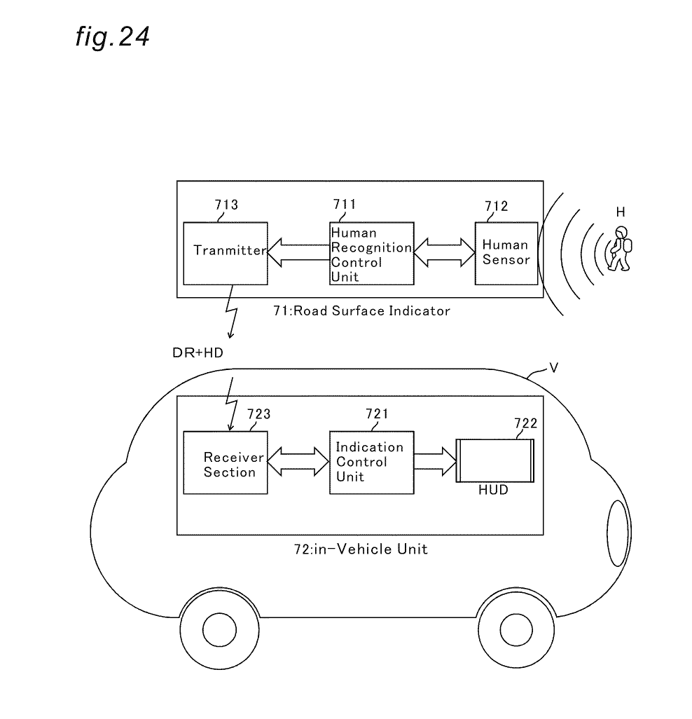

An indication state of the head up display (HUD) of vehicle V1 is shown in FIG. 22. Because the existence of a walker becoming the blind spot is displayed as shown in FIG. 22 by the head up display of a driving vehicle, even the present embodiment can prevent the accident with a walker (or a bicycle) and the vehicle in the intersection. Note that, in FIG. 20, one surface of road surface indicator 61 is provided with three cameras, and that view gets narrow by mud is prevented. FIG. 23 is a whole illustration showing the seventh embodiment (the variation of the sixth embodiment). As shown in FIGS. 23 and 24, as for intersection safety system 700 of the present embodiment, it is from the in-vehicle unit 72 registered by road surface indicator 71 installed in the center of the intersection and a vehicle (it is shown in FIG. 23 in V1, V2 in FIG. 24 as shown in V). Road surface indicator 71 becomes human recognition control unit (a control unit) 711 from human sensor (a GPS terminal position receiving set) 712 and transmitter 713. The in-vehicle unit 72 consists of indication control unit (a control unit) 721 and head up display 722, receiver 723.

Human recognition control unit 711 can receive the location information from the GPS terminal which the walker (or a bicycle driver) near the intersection carries by human sensor 712. When there is location information near a intersection, human recognition control unit 711 transmits predetermined information (direction information DR and human detection information HD) to receiver 723 of vehicle V1 from transmitter 713. Indication control unit 721 performs nudge indication to a head up display (HUD) in vehicle V1.

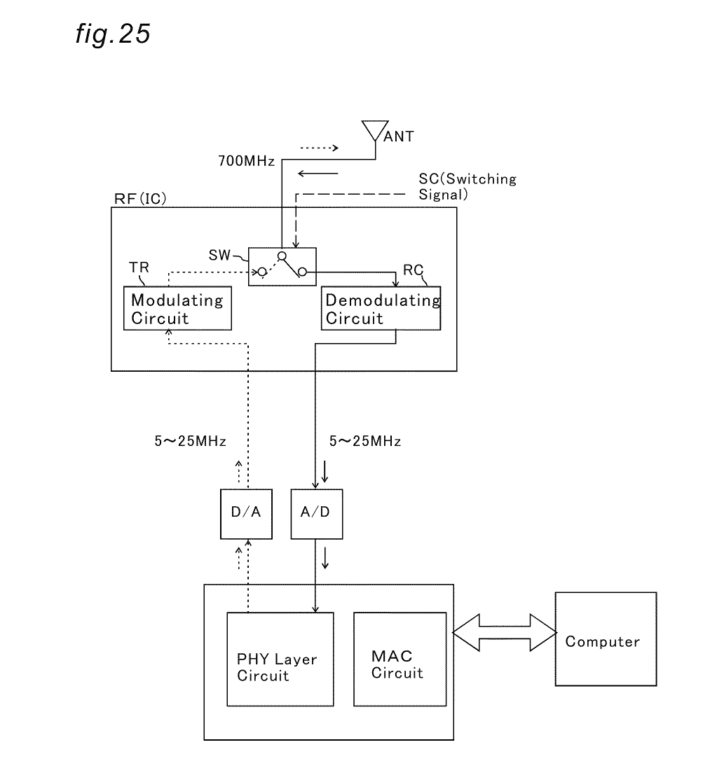

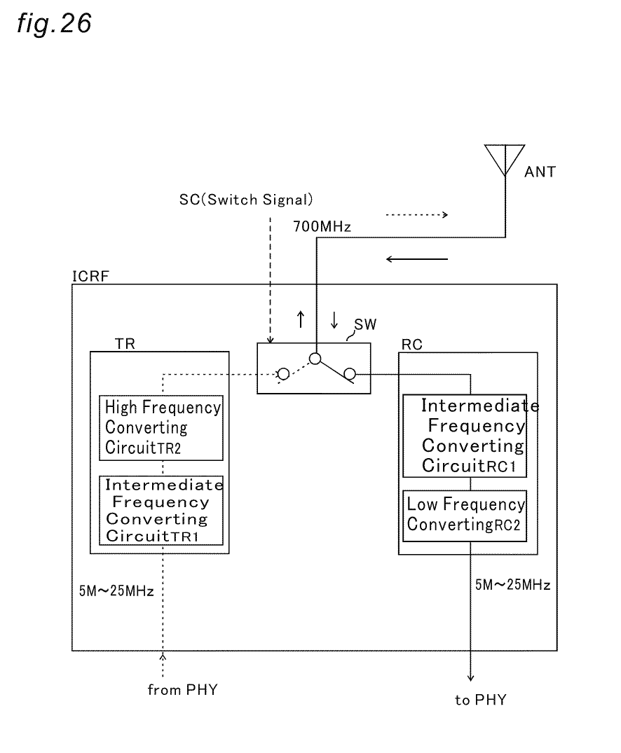

FIGS. 25 and 26 are illustrations showing the embodiments of the RF integrated circuit of the present invention. In FIG. 25, RF integrated circuit RFIC comprises demodulation circuit RC, modulation circuit TR and switching circuit SW. RF integrated circuit RFIC is connected to physical layer circuit PHY and a circuit comprising the media access circuit MAC, and the circuit is connected to a computer CPU.

The demodulation circuit RC reduces a radio frequency band signal (here a signal of 715M-725 MHz) received by an antenna in arbitrary frequency (from 5 MHz 20 MHz), and it is output for physical layer circuit PHY. Modulation circuit TR raises a signal of arbitrary frequency (from 5 MHz 20 MHz) input from physical layer circuit PHY in a radio frequency (a signal of 715M-725 MHz), and it is output in antenna ANT.

The physical layer circuit PHY is typically an interface circuit. In this embodiment, it is provided with analog/digital converter A/D, digital-to-analog converter D/A between physical layer circuit PHY and RF integrated circuit RFIC. These can be also made for physical layer circuit PHY, and it can be established in RF integrated circuit RFIC. The physical layer circuit PHY is connected to media access circuit MAC, and the signal from demodulation circuit RC is handed to media access circuit MAC, and the signal from media access circuit MAC is handed to modulation circuit TR. The antenna AND is connected to demodulation circuit RC and modulation circuit RC through switching circuit SW. Switching circuit SW can change antenna ANT to either of demodulation circuit RC and the modulation circuit RC by change signal SC from the outside.

Note that, the demodulation circuit RC can be comprised as shown in FIG. 26 from intermediate frequency converter circuit RC1 and low frequency converter circuit RC2. Intermediate frequency converter circuit RC1 converts radio frequency signal input through switching circuit SW into intermediate frequency, and it is further converted into frequency of around 5-25 MHz by low frequency converter circuit RC2. And, these signal frequency our particular signal frequency is output for physical layer circuit PHY of FIG. 25. Also, as shown in FIG. 26, the modulation circuit RC can be further comprised from high frequency converter circuit TR2 with intermediate frequency converter circuit TR1. Particular signal frequency of the signal frequency from physical layer circuit PHY is converted into intermediate frequency by intermediate frequency converter circuit TR1. Even more particularly, a signal of this intermediate frequency is modulated to the signal of the radio frequency (a 700 MHz zone) by high frequency converter circuit TR2, and, through switching circuit SW, it is output in antenna ANT.

In the attached drawings, the following reference numerals correspond to:

1A-1D vehicle detection unit

2, 5, 31, 61, 71 road surface indicators

A human from 4A-4D detection unit

8A-8D traffic sign

32, 62, 72 the in-vehicle units

33, 63 antennas

100,200,300,400,500,600,700 intersection safety system

112,212A-212D, 111,211,311 113,313,413,613,713 312A vehicle sensor vehicle recognition control unit transmitters

121,221,321,421,521,612,721 indication control unit

122,222A-222D, 123,323,423,623,723 322,622,722 422,522A-522D indicate lamp receiver head up display

412,512A-512D, 612A-612D, 712 411,511,611,711 sensor recognition control unit DR direction information

H walker

HD human detection information

V1, V2 vehicle

VD vehicle detection information

I claim:

1. The traffic sign comprising a vehicle sensor and indicating lamp and a control unit is the intersection safety driving system which is installed in each entrance, respectively, of the intersection, wherein,
the intersection safety driving system including displaying to rouse the attention to the above vehicle in indicate lamp comprised on the traffic sign installed in the road which the vehicle drives when the vehicle which is going to come in the above intersection was detected and the intersecting road by the vehicle sensor that the control unit was comprised to the vicinities of a intersection.

2. The road surface indicator comprising a vehicle sensor and indicating lamp and a control unit is the intersection safety driving system installed in the center of the intersection, wherein,
when the vehicle which is going to come in the cross point by the vehicle sensor was detected, the control unit displays indication to rouse attention to the other vehicles which are going to come in the intersection among vehicles driving the road which the vehicle drives and an intersecting road in above indicate lamp.

3. The intersection safety driving system that a vehicle sensor and a transmitter and the vehicle detection facilities comprising the control unit are installed in the intersection, and an above transmitter transmits information to a vehicle comprising the receiver circuit, wherein,
when the vehicle which there is which is going to come in the cross point by the vehicle sensor was detected, the control unit transmits information to suffer from the above detection to a vehicle comprising the above receiver circuit which is going to come in the intersection among vehicles driving the road which the vehicle drives by an above transmitter and an intersecting road.

4. The intersection safety driving system that a human sensor and indicating lamp and the traffic sign comprising a control unit are installed in each entrance of the intersection, respectively, wherein,
when a human or a bicycle was detected by the human sensor comprised to the vicinities of a intersection in the vicinity of a intersection, the control unit performs indication to rouse the attention to an above human or the above bicycle in indicate lamp comprised on each traffic sign.

5. The intersection safety driving system that a human sensor and indicating lamp and the road surface indicator comprising a control unit are installed in the center of the intersection, and it is, wherein,
when a human was detected by the human sensor comprised to the vicinities of a intersection in the vicinity of a intersection, the control unit performs indication to rouse the attention to an above human or the above bicycle in indicate lamp comprised to each road surface indicator.

6. A human sensor and a transmitter and the human detection facilities comprising the control unit are installed in the crossover, and the transmitter transmits information to a vehicle comprising the receiver circuit, wherein,
when a human passing the intersection neighborhood by the human sensor was detected, the control unit transmits information to suffer from the above detection to the above vehicle which is going to come in the intersection among vehicles driving the road which the human passes by an above transmitter and an intersecting road.

7. The intersection safety driving system that a mobile station radio unit comprised on the preparation et al. obtained fixed station radio unit and vehicle on a traffic sign communicates, wherein
a signal of the arbitrary frequency which the fixed station radio unit and the mobile station radio unit reduce a radio frequency band signal received by an antenna in arbitrary frequency, and was input into other circuits from a demodulation circuit to output and the circuit of above others is raised in a radio frequency, and an RF integrated circuit for the development that had the switching circuit which changes a modulation circuit to output and an above antenna to either of an above demodulation circuit and the above modulation circuit built-in is comprised to the above antenna, and the RF integrated circuit is made accumulation independently with the circuit of above others and the above demodulation circuit converts received radio frequency signal into a signal of the low frequency, and the above modulation circuit converts a signal of the low frequency into radio frequency signal.
